(19) United States
(12) Patent Application Publication
(10) Pub. No.: US 2016/0230302 A1
(43) Pub. Date: Aug. 11, 2016

(54) METHOD OF TREATING METAL SURFACES

(71) Applicant: Hewlett-Packard Development Company, L.P., Houston, TX (US)

(72) Inventors: Yu-Chuan (Tony) KANG, Taipei City (TW); Kuang-Ting WU, Taipei City (TW)

(21) Appl. No.: 15/021,578

(22) PCT Filed: Oct. 31, 2013
(86) PCT No.: PCT/US2013/067706

§ 371 Date: Mar. 11, 2016

(51) Int. Cl. C25D 11/20; C25D 11/10; C25D 11/06; H04B 1/3888; C25D 11/24; C25D 11/18; C25D 11/26; C25D 11/30; C25D 11/02; C25D 11/16

(52) U.S. Cl. CPC C25D 11/20; C25D 11/022; C25D 11/024; C25D 11/026; C25D 11/10; C25D 11/06; C25D 11/16; C25D 11/24; C25D 11/18; C25D 11/26; C25D 11/30; H04B 1/3888

(57) ABSTRACT

A method is provided for treating a metal surface. The method comprises electrochemically treating the metal surface to form a first metal oxide coating, removing a portion of the first metal oxide coating to form and exposed metal surface, and electrochemically treating the exposed metal surface to form a second oxide coating on the metal surface.

### BACKGROUND

Devices such as mobile phones, tablets and portable (e.g. laptop or palm) computers are generally provided with a casing. The casing typically provides a number of functional features, e.g. protecting the device from damage.

Increasingly, consumers are also interested in the aesthetic properties of the casing such as the look, colour and style. In addition, devices such as mobile phones, tablets and portable computers are typically designed for hand held functionality, thus the consumer may also consider the weight of the device and the feel of the casing by which they hold the device.

### BRIEF DESCRIPTION OF DRAWINGS

By way of non-limiting examples, device casings and processes of manufacturing such casings according to the present disclosure will be described with reference to the following drawings in which

FIG. 1 is a flow diagram illustrating an example of a method of treating a metal surface

FIG. 2 is a flow diagram illustrating another example of a method of treating a metal surface

FIG. 3A is a sectional top view of an example of a treated metal surface having two metal oxide coatings produced by the method of FIG. 1 or FIG. 2

FIG. 3B is a sectional side view of the treated metal surface of FIG. 3a along the line 3-3

FIG. 4A is a sectional top view of an example of a treated metal surface having three metal oxide coatings produced by the method of FIG. 1 or FIG. 2

FIG. 4B is a sectional side view of the treated metal surface of FIG. 4a along the line 4-4

FIGS. 5A-5C are sectional side views of examples of treated metal surfaces produced by the method of FIG. 1 or FIG. 2

FIG. 6A is a perspective view of an example of a casing produced by the method of FIG. 1 or FIG. 2

FIG. 6B is a sectional perspective view of the casing of FIG. 6a

### DETAILED DESCRIPTION

The present disclosure describes a method of treating a metal surface, for example a casing for a device. The method comprises the formation of a first metal oxide coating to cover the metal surface through an electrochemical treatment of the metal surface. Portions of the first metal oxide coating are then removed, for example using chemical or laser etching, to expose portions of the underlying metal surface. This exposed metal surface is then treated electrochemically to form a second metal oxide coating at the site of the exposed metal.

The relatively high voltages used by the disclosed method results in the formation of comparatively thick metal oxide coatings in less time when compared to other oxidation methods. This results in a higher throughput of casings in manufacturing settings.

Furthermore, the disclosed method provides for improved environmental, health and safety factors, requiring less toxic and environmentally harmful electrolytic solutions, and by providing a safer method for treating volatile metals such as magnesium and its alloys.

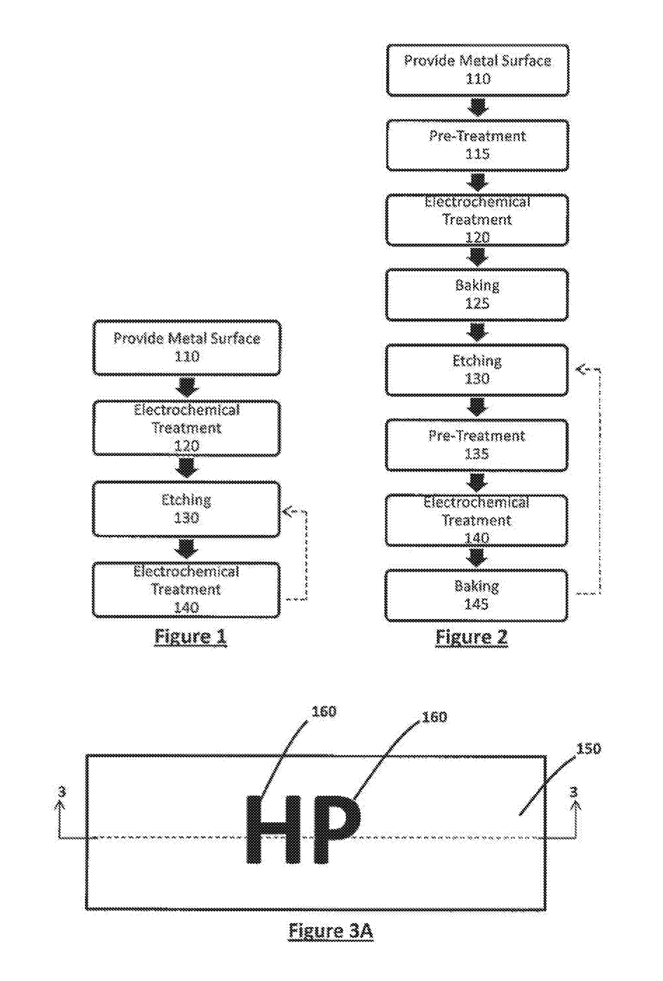

FIGS. 1 and 2 illustrate examples of methods of manufacturing a casing.

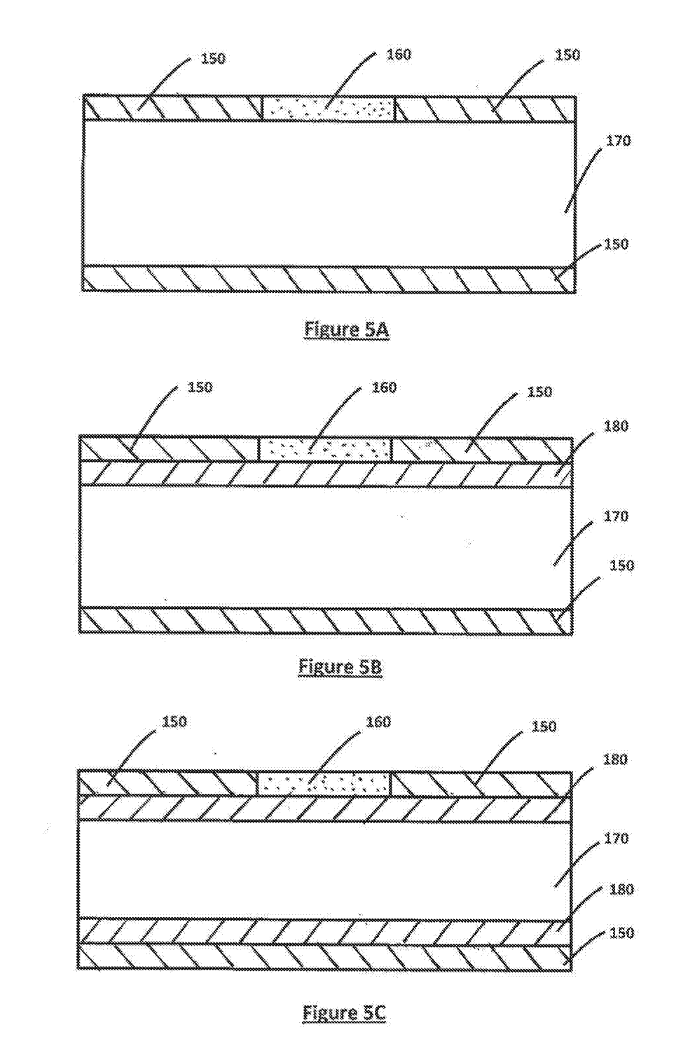

Referring to FIG. 1, a metal surface is provided (110). The metal surface may be, for example, in the form of a casing for a device. The casing can be formed using conventional methods, such as stamping or moulding, into the desired shape of the finished product. In one example, the casing is formed of a single layer of metal, typically a light metal such as aluminium, magnesium, titanium or alloys thereof, resulting in a product such as that shown in FIG. 5A. In another example, the casing may be formed of two or more layers of a combination of metals, resulting in products such as those shown in FIGS. 5B and 5C.

The metal surface is electrochemically treated (120) to form a first metal oxide coating. Depending on the conditions of the electrochemical treatment and the metal being treated, the disclosed method can be used and may vary to form metal oxide coatings of 1-300 μm in thickness and more preferably 3-50μ in thickness. In comparison, metal oxide coatings formed by other techniques are typically in the range of 0.001-0.1 μm.

Referring to FIG. 1, after electrochemically treating the metal surface (120), portions of the first metal oxide coating are removed (130), for example by chemical or laser etching, exposing underlying portions of the metal surface. These exposed portions of the underlying metal undergo a further electrochemical treatment (140) thereby forming a second oxide coating. This second metal oxide coating may fill in the areas of the first metal oxide's coating that were removed, providing a continuous metal oxide coating on the metal surface formed of two different metal oxide materials.

As shown in FIG. 1, the oxide removal (etching) (130) and electrochemical treatment (140) may be repeated numerous times to achieve the desired number of metal oxide coatings on the surface of the metal.

The electrochemical treatment includes applying a voltage greater than the oxide coating's dielectric breakdown potential to the metal surface in an electrolytic solution.

The dielectric breakdown potential of a material is the voltage applied via an electric field that the material can withstand without breaking down. When a material such as a metal oxide is treated with a potential greater than its dielectric breakdown potential, the breakdown results in a disruptive discharge through the metal.

The dielectric breakdown potential of a material varies depending on a number of factors, for example the composition, thickness and temperature of the material.

An example of a suitable electrochemical process includes micro-arc oxidation (also known as plasma electrolytic oxidation). Micro-arc oxidation is an electrochemical surface treatment process for generating oxide coatings on metals.

In one example of micro-arc oxidation, a metal is immersed in a bath of electrolyte, typically an alkali solution such as potassium hydroxide. The casing is electrically connected so as to become one of the electrodes in the electrochemical cell, with the wall of the bath, typically formed of an inert material such as stainless steel, acting as the counter-electrode. A potential is applied between the two electrodes, which may be continuous or pulsing, and direct current or alternating current.

Other electrochemical treatments include anodising. In anodising, a reduced voltage is used such that the disruptive discharges observed in micro-arc oxidation do not occur. As a result, the electrolytic solutions used in anodising are typically corrosive acid solutions which act to form pores through the forming oxide coating to the metal surface, allowing the oxide coating to continue growing. The use of these corrosive acids can add complexities to the manufacturing process with the increased requirements of using, handling and disposing of the chemicals as compared to the safer and less toxic alkali solutions of the micro-arc oxidation process.

As potentials used in micro-arc oxidation are greater than the dielectric breakdown potential of the forming metal oxide coating, disruptive discharges occur and the resulting high temperature, high pressure plasma modifies the structure of the oxide coating. This results in an oxide coating that is porous and with the oxide in a substantially crystalline form.

In addition, oxide coatings formed in the above manner are conversion coatings, converting the existing metal material into the oxide coating. This conversion of the metal provides a good adhesion of the oxide coating to the metal relative to oxide coatings deposited on the metal surface as occurs using other methods.

Properties of the oxide coating such as porosity, hardness, colour, conductivity, wear resistance, toughness, corrosion resistance, thickness and adherence to the metal surface can be varied by varying the parameters of the electrochemical treatment. Such parameters include the electrolyte (e.g. temperature and composition), the potential (e.g. pulse or continuous, direct current or alternating current, frequency, duration and voltage) and the processing time.

In one example, the resulting colour of a titanium dioxide coating can be varied by varying the voltage applied. In another example, organic acid can be added to the electrolyte to allow for thicker oxide coatings to be formed.

Referring to FIG. 2, after electrochemical treatment the oxidised metal surface may undergo baking (125, 145), for example to remove any remaining electrolytic solution. Furthermore, the metal surface and/or metal oxide may be pre-treated (115, 135) prior to micro-arc oxidation.

Pre-treatment (115, 135) of the metal surface and/or metal oxide coating can be used to alter the visual, tactual and textural properties of the casing, or to otherwise prepare the casing for the electrochemical process. Examples of pre-treatment processes relating to the visual, tactual and textural properties of the casing include: dyeing, painting, spray coating, sputter coating, electrophoretic deposition, nano-coating, chemical vapour deposition and physical vapour deposition. Examples of pre-treatment processes relating to preparing the casing for the electrochemical process include: degreasing, cleaning, buffing or polishing.

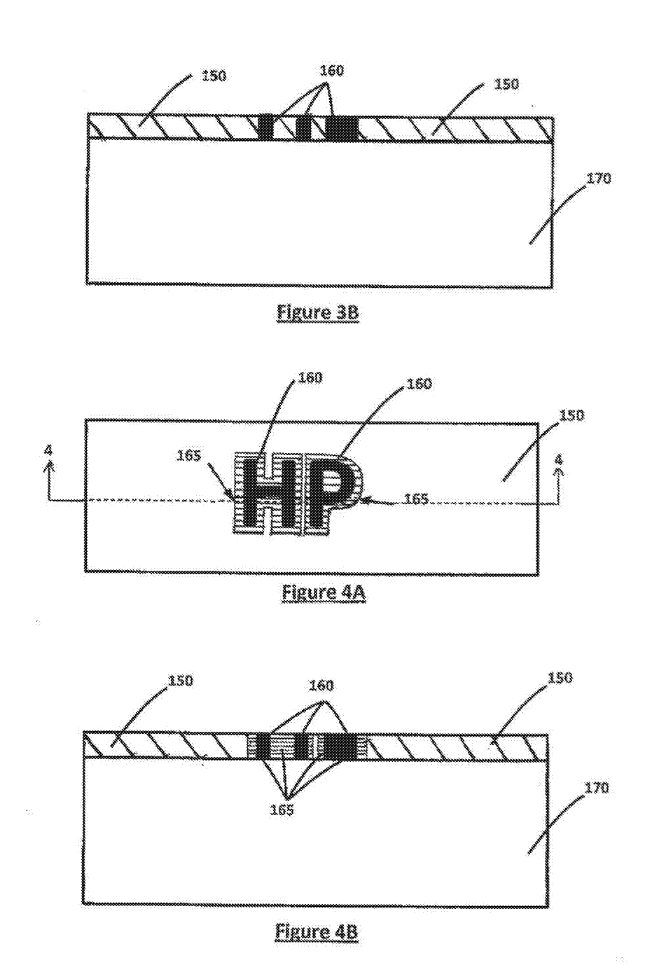

FIGS. 3A and 3B show an example of a metal surface treated according to the method shown in FIG. 1 or 2. As shown in the example of FIG. 3B, the etching (130) and subsequent electrochemical treatment (140) allow for the two oxide coatings (150, 160) to form distinct patterns on the surface of the casing, in this example the letters “HP”. In addition to letters and numbers, the process of FIGS. 1 and 2 could be used, for example, to produce patterns and pictures. By repeating the etching and electrochemical treatments a number of different metal oxide coatings can be formed, the different metal oxide coatings having different functional, physical, visual, tactual and textual properties.

FIGS. 4A and 4B show the treated metal surface of FIGS. 3A and 3B having undergone an additional etching and electrochemical treatment to form a third oxide coating (165), in this example outlining the “HP”lettering shown in FIG. 3A.

FIGS. 5A-5C show examples of a metal surface coated by a method as shown in FIG. 1 or 2. The coated product shows a number of layers (not to scale): a first metal layer (170), first and second metal oxide coatings (150, 160) on the metal surface and, in the examples shown in FIGS. 5B and 5C, a second metal component (180).

In the examples shown in 5B and 5C, the presence of the second metal component (180) can protect the first metal layer (170) from undergoing repeated electrochemical treatments. The presence of a second metal layer may be used, for example, when the first metal (175) has desired properties for the casing (e.g. strength, low weight) however another metal (e.g. 180) is more suited to the electrochemical process or provides an oxide coating with preferred properties (e.g. colour, conductivity, hardness etc).

For example magnesium and its alloys are easily corroded and form potentially explosive hydrogen gas as a by-product of its reaction with water. Magnesium also reacts exothermically with acids, making processes such as anodisation, where corrosive acids are used as the electrolyte, a potentially hazardous treatment for magnesium and its alloys. However, magnesium and its alloys have many physical properties suitable for use in casings, such as their strength and light weight. The disclosed method allows for a relatively safer method of treating and utilising magnesium and its alloys in casing and the like.

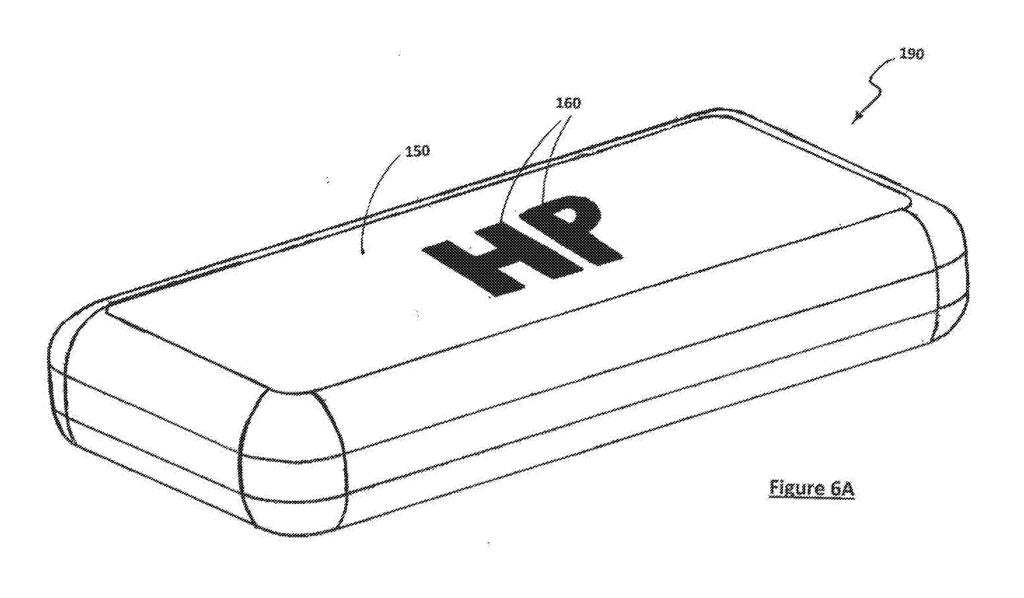

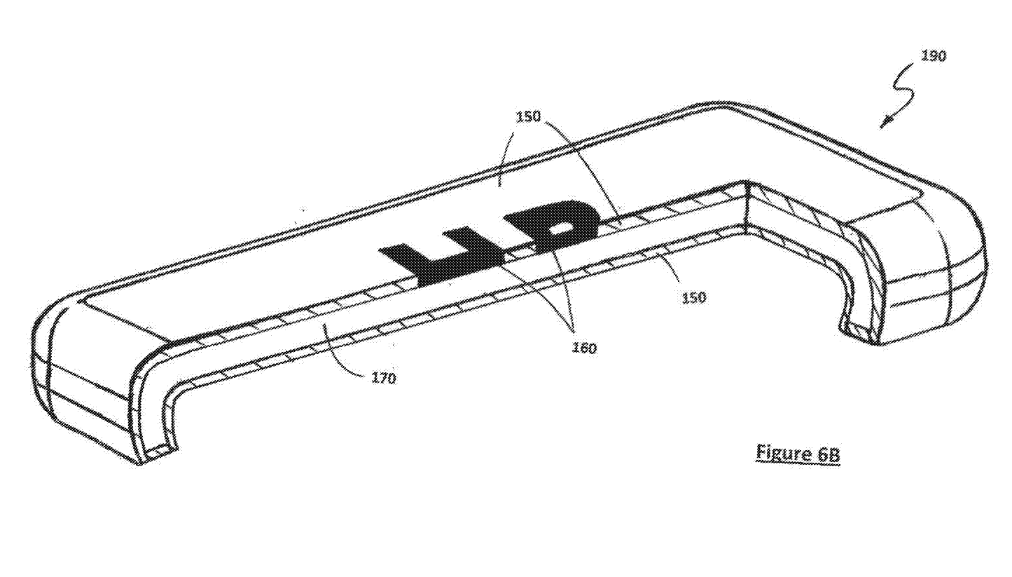

FIGS. 6A and 6B provide on example of a casing (190) for a smart phone coated by the method described herein. Referring to FIG. 6B, the casing has a first metal layer (170), a first metal oxide coating (150) on the metal surface and a second metal oxide coating (160) on the metal surface depicting the letters “HP”.

It will be appreciated that numerous variations and/or modifications may be made to the above-described examples, without departing from the broad general scope of the present disclosure. The present examples are, therefore, to be considered in all respects as illustrative and not restrictive.

1. A method of treating a metal surface, the method comprising
treating the metal surface with micro-arc oxidation to form a first metal oxide coating on the metal surface,
removing a portion of the first metal oxide coating to form an exposed metal surface, and
treating the exposed metal surface with micro-arc oxidation to form a second metal oxide coating on the exposed metal surface.

2. A method according to claim 1, wherein the metal surface comprises aluminium, magnesium, titanium, their alloys or combinations thereof.

3. A method according to claim 1, wherein removing portions of the metal oxide coating comprises etching.

4. A method according to claim 3, wherein etching is chemical etching or laser etching.

5. A method according to claim 1, comprising removing portions of the first metal oxide coating and/or the second metal oxide coating to form a further exposed metal surface and treating the further exposed metal surface with micro-arc oxidation to form a third metal oxide coating on the further exposed metal surface.

6. A method according to claim 1, further comprising baking the metal surface with the first metal oxide coating.

7. A method according to claim 1, further comprising pre-treating the metal surface and/or the first metal oxide coating prior to treating with micro-arc oxidation.

8. A method of manufacturing a casing for a device, the casing having a metal surface, the method comprising
electrochemically treating the metal surface to form a first metal oxide coating having a dielectric breakdown potential, the electrochemical treatment comprising applying a first voltage to the metal surface in a first electrolytic solution, wherein the voltage applied is greater than the dielectric breakdown potential of the first metal oxide coating,
removing a portion of the first metal oxide coating to form an exposed metal surface, and
electrochemically treating the exposed metal to form a second metal oxide coating having a dielectric breakdown potential, the electrochemical treatment comprising applying the first or a second voltage to the exposed metal surface in the first or a second electrolytic solution, wherein the voltage applied is greater than the dielectric breakdown potential of the second metal oxide coating.

9. A method according to claim 8, wherein the electrolytic solutions comprise dilute alkali solutions.

10. A method according to claim 8, wherein the electrolytic solutions further comprise an organic acid.

11. A method according to claim 8, wherein the first and/or the second voltage is a pulsed direct current.

12. A casing for a portable device comprising
a metal surface,
a first metal oxide coating of the metal surface formed by micro-arc oxidation of the metal surface, and
a second metal oxide coating formed by micro-arc oxidation of the metal surface.

13. A casing according to claim 12, wherein the first metal oxide coating and the second metal oxide coating form a continuous coating of the metal surface.

14. A casing according to claim 12 wherein the first metal oxide coating and the second metal oxide coating have different functional, physical, visual, tactual and/or textual properties.
